(19) United States
(12) Patent Application Publication
(10) Pub. No.: US 2026/0326711 A1
(43) Pub. Date: Oct. 22, 2026

(54) METHOD FOR OPERATING A VEHICLE AND VEHICLE

(71) Applicant: MERCEDES-BENZ GROUP AG, Stuttgart (DE)

(72) Inventor: Gerd SCHEIDHAUER, Weingarten (Baden) (DE)

(21) Appl. No.: 19/491,116

(22) PCT Filed: Apr. 25, 2024
(86) PCT No.: PCT/EP2024/061423

§ 371 Date: Dec. 8, 2025

(30) Foreign Application Priority Data
Jun. 9, 2023 (DE) 10 2023 002 356.6

(51) Int. Cl. B60R 25/00; B62D 5/00; B62D 5/04

(52) U.S. Cl. CPC B60R 25/007; B62D 5/001; B62D 5/0418; B62D 5/046

(57) ABSTRACT

A vehicle with steer-by-wire steering device includes a software-based immobilizer. In an activated state of the immobilizer, the transmission of steering information to a data bus and/or the control of a wheel of a steering axle are/is blocked by software.

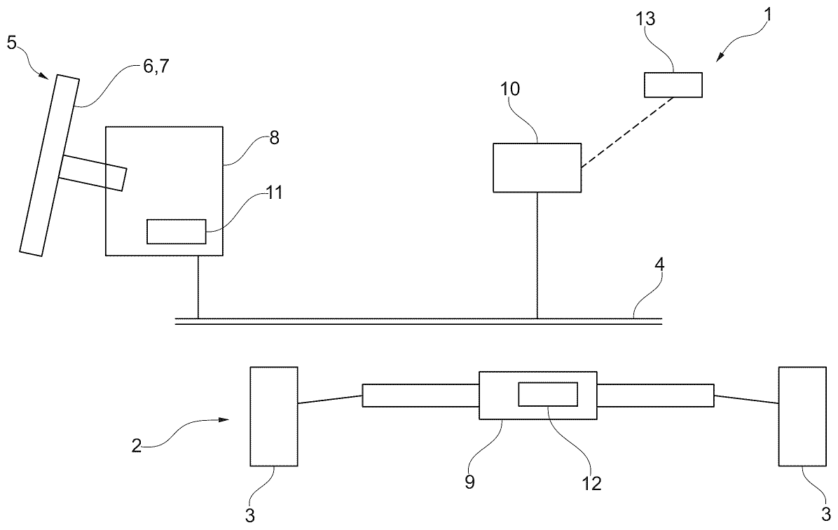

### BACKGROUND AND SUMMARY OF THE INVENTION

Exemplary embodiments of the present invention relate to a method for operating a vehicle having a steer-by-wire steering device and an immobilizer, as well as to a vehicle operated in this way.

For steering a vehicle, the vehicle usually has a steering encoder, in particular a steering wheel, which can be moved accordingly. In the process, at least one steerable wheel of the vehicle is moved depending on the steering movement of the steering encoder.

An associated steering device is increasingly in the form of a so-called steer-by-wire steering device, in which there is no direct connection between the steering encoder and the at least one wheel.

Vehicles generally have an immobilizer, by means of which it is possible to prevent the vehicle from being steered.

DE 100 46 167 A1 discloses a vehicle of this type. In the vehicle, the immobilizer is implemented by means of mechanical locking of the steering device.

DE 10 2009 060 354 A1 discloses a vehicle with a steer-by-wire steering device and an immobilizer. To improve theft protection, normal use of the vehicle is prevented when, upon activation of an ignition of the vehicle, it is established that the immobilizer is in an unlocked state, i.e., the immobilizer is in a deactivated state.

Exemplary embodiments of the present invention are directed to a method for operating a vehicle of the type mentioned in the introduction and for such a vehicle, improved or at least other embodiments which are characterized in particular by a reduced overall space requirement, a reduced weight and reduced costs.

The present invention is accordingly based on the basic idea of implementing the function of an immobilizer by means of electronic influence, in that the transmission of steering information from a steering encoder to a steering actuator and/or the control of a wheel by means of the steering actuator is blocked by software. In this way, mechanical components for implementing the immobilizer can be dispensed with, resulting in a more compact configuration and more cost-effective production of a steering device comprising the steering encoder, and in particular of the steering encoder. The more compact configuration of the steering encoder makes it possible, in particular, to design the steering encoder to be movable, in particular foldable, such that, if required, it can be accommodated with a reduced overall space requirement, in particular during autonomous driving of the vehicle.

According to the inventive idea, the vehicle has a steering axle, at least one wheel associated with the steering axle, and a data bus. The vehicle also has a steer-by-wire steering device, which is also referred to below as steering device for short. The steering device comprises the steering encoder and a component, connected to the steering encoder, for sensing a steering movement of the steering encoder, this also being referred to as steering pickup component below. In addition, the steering device comprises a steering actuator for controlling the at least one wheel of the steering axle. The immobilizer of the vehicle is connected to the data bus for communication. The immobilizer is switchable between an activated state and a deactivated state, wherein the immobilizer blocks steering of the vehicle in the activated state and enables it in the deactivated state. If the immobilizer is deactivated, i.e., is in the deactivated state, the steering pickup component senses the steering movement of the steering encoder and transmits steering information dependent on the steering movement to the data bus. The steering actuator receives the steering information via the data bus and controls the at least one wheel of the steering axle depending on the steering information. If the immobilizer is activated, i.e., is in the activated state, the transmission of the steering information to the data bus is blocked in the steering pickup component by software, and/or the control of the at least one wheel of the steering axle is blocked in the steering actuator by software.

In preferred embodiments, the software-based implementation of the blocking of the transmission of the steering information to the data bus is implemented with a blocker integrated by software in the steering pickup component, this also being referred to as pickup blocker below. The pickup blocker is thus integrated by software in the steering pickup component. The immobilizer communicates with the pickup blocker via the data bus. In this case, the immobilizer activates the pickup blocker in the activated state, i.e., via the data bus, such that the pickup blocker blocks the transmission of the steering information to the data bus.

Expediently, the pickup blocker is deactivated in the deactivated state of the immobilizer.

Preference is given to embodiments in which the software-based implementation of the blocking of the control of the at least one wheel of the steering axle is implemented in the steering actuator with a blocker integrated in the steering actuator, this also being referred to as encoder blocker below. The encoder blocker is thus integrated by software in the steering actuator. The immobilizer communicates with the encoder blocker via the data bus. In this case, the immobilizer activates the encoder blocker in its activated state, such that the encoder blocker blocks the control of the at least one wheel of the steering axle.

Preference is given to variants in which the communication between the immobilizer and the pickup blocker and/or the encoder blocker takes place cryptographically. This means that the communication of the immobilizer with the pickup blocker and/or encoder blocker is protected from manipulation by cryptographic data. This results in improved security and improved theft protection.

The cryptographic communication may be implemented, for example, by means of a challenge-response method based on a symmetric cipher, and/or by means of a keyed-hash message authentication code, also going by the abbreviation “HMAC”, and/or by means of a block cipher-based message authentication code, also going by the abbreviation “CMAC”. In this case, advantageously, the respectively used cryptographic key is generated individually for the steering pickup component, in particular for the pickup blocker, and for the steering actuator, in particular for the encoder blocker. Preferably, in addition, the challenge of the steering pickup component, in particular of the pickup blocker, and/or of the steering actuator, in particular of the encoder blocker, is generated using a cryptographic random number generator.

Alternatively or additionally, the cryptographic communication can be implemented via an asymmetric signature method and/or by means of a method based on digital certificates.

Alternatively or additionally, the cryptographic communication can be implemented by means of a one-time password method.

Preferably, a device for access and driving authorization is provided for the vehicle. The device, also referred to as access and driving authorization device below, serves the purpose, in particular, of switching the immobilizer between the activated state and the deactivated state. Likewise, the access and driving authorization device can serve to activate and deactivate a door lock of the vehicle and/or to start the vehicle.

The access authorization device may be, for example, a vehicle key or comprise a vehicle key. Alternatively or additionally, the access authorization device may be or comprise an individually encoded electronic device, for example a smartphone. The access authorization device may, alternatively or additionally, be implemented by means of a cryptographic code which is transmitted to the vehicle via a wireless data connection, i.e., in particular, online.

Advantageously, the immobilizer is in the activated state and/or is switched into the activated state in a rest state of the vehicle.

It is understood that, in addition to the method, the scope of this invention also includes a vehicle operated in this way. The vehicle, and in particular the steering pickup component and/or the steering actuator, are configured accordingly.

The steering encoder may, in principle, have any configuration. In particular, the steering encoder may be a steering wheel.

Preferably, the steering encoder is free of mechanical locks in order to implement the immobilizer. This results, as explained above, in a compact design of the steering encoder and reduced production costs.

Preferably, the steering encoder is foldable. Particularly preferably, the steering encoder is foldable and free of mechanical locks. Thus, the steering encoder can be accommodated in a compact manner as required, in particular in an autonomous driving mode of the vehicle, and requires less installation space, or no installation space, in the vehicle, in particular in the passenger compartment.

Advantageously, the steering device and/or the immobilizer is, as a whole, free of mechanical locks.

Preferably, the steering device is free of mechanical locks between the steering encoder and the steering pickup component. This results in an even more compact design and further reduced production costs.

Alternatively or additionally, preferably additionally, the steering device is preferably free of mechanical locks between the steering actuator and the at least one wheel of the steering axle.

Further important features and advantages of the invention will become apparent from the dependent claims, from the drawings and from the associated description of the figures with reference to the drawings.

It is understood that the features mentioned above and the features still to be explained below can be used not only in the respectively specified combination, but also in other combinations or on their own, without departing from the scope of the present invention.

A preferred exemplary embodiment of the invention is illustrated in the drawing and explained in more detail in the following description, wherein identical reference signs refer to identical or similar or functionally identical components.

### BRIEF DESCRIPTION OF THE SOLE DRAWING FIGURE

In the drawing:

The sole drawing FIGURE shows a highly simplified, schematic and diagrammatic illustration of a vehicle.

### DETAILED DESCRIPTION

A vehicle 1, as is illustrated in a highly simplified and diagrammatic manner in the sole drawing FIGURE, has a steering axle 2 and at least one wheel 3 associated with the steering axle 2. In the exemplary embodiment shown, the vehicle 1 has, purely by way of example, two wheels 3 associated with the steering axle 2. The vehicle 1 has a data bus 4 for data transmission. For steering the vehicle 1, the vehicle 1 has a steering device 5, which is in the form of a steer-by-wire steering device 5. The steering device 5 has a steering encoder 6, which can be moved by a user, wherein such a movement of the steering encoder 5 is referred to as steering movement below. In the exemplary embodiment shown, the steering encoder 6 is, purely by way of example, in the form of a steering wheel 7. The steering device 5 also has a component 8 for sensing the steering movement of the steering encoder 6, which is connected to the steering encoder 6 and is referred to as steering pickup component 8 below. The steering pickup component 8 is capable of transmitting steering information dependent on the steering movement of the steering encoder 6 to the data bus 4. The steering device 5 also has an actuator 9 for controlling the at least one wheel 3 of the steering axle 2, which is also referred to as steering actuator 9 below. The steering actuator 9 is thus capable of controlling the at least one wheel 3 in order to steer the vehicle 1. The vehicle 1 also has an immobilizer 10. The immobilizer 10 is able to be activated and deactivated, i.e., able to be switched between an activated state and a deactivated state.

If the immobilizer 10 is deactivated, i.e., is in the deactivated state, the steering pickup component 8 senses the steering movement of the steering encoder 6 and transmits steering information dependent on the steering movement to the data bus 4. The steering actuator 9 receives the steering information via the data bus 4 and controls the at least one wheel 3 of the steering axle 2 depending on the steering information.

If the immobilizer 10 is activated, i.e., is in the activated state, steering of the vehicle 1 is prevented and thus blocked. For this purpose, the transmission of the steering information to the data bus 4 is blocked in the steering pickup component 8 by software and/or the control of the at least one wheel 3 is blocked in the steering actuator 9 by software. In the exemplary embodiment shown, in the activated state of the immobilizer 10 both the transmission of the steering information to the data bus 4 is blocked in the steering pickup component 8 and the control of the at least one wheel 3 is blocked in the steering actuator 9, in each case by software.

The implementation of the respective software-based blocking function takes place, in the exemplary embodiment shown, by means of the integration of a respectively associated software-based blocker 11, 12 and electronic communication of the immobilizer 10 with the respective software-based blocker 11, 12 via the data bus 4.

In this case, an associated blocker 11 is integrated by software in the steering pickup component 8, this also being referred to as pickup blocker 11 below. The immobilizer 10 communicates with the pickup blocker 11 via the data bus 4. The immobilizer 10 in this case activates the pickup blocker 11 in the activated state, such that the pickup blocker 11 blocks the transmission of the steering information to the data bus 4. In the deactivated state of the immobilizer 10, the pickup blocker 11 is deactivated, such that the steering information is transmitted to the data bus 4.

An associated blocker 12 is integrated by software in the steering actuator 9, this also being referred to as encoder blocker 12 below. The immobilizer 10 communicates with the encoder blocker 12 via the data bus 4. The immobilizer 10 in this case activates the encoder blocker 12 in the activated state, such that the encoder blocker 12 blocks the control of the at least one wheel 3. By contrast, the encoder blocker 12 is deactivated in the deactivated state of the immobilizer 10, such that the steering actuator 9 controls the at least one wheel 3 depending on the steering information.

Thus, the immobilizer function is implemented without a corresponding mechanical lock. Accordingly, as can be gathered from the sole drawing FIGURE, the steering device 5 is free of mechanical locks between the steering encoder 6 and the steering pickup component 8 and between the steering actuator 9 and the at least one wheel 3 of the steering axle 2 in the exemplary embodiment shown. In addition, the steering encoder 6 is free of mechanical locks and thus formed in a compact manner.

In the exemplary embodiment shown, the steering encoder 6 is also foldable. Thus, the steering encoder 6, in particular due to the lack of a mechanical lock, can be folded more easily and can be accommodated in a space-saving manner, for example, during the autonomous driving of the vehicle 1.

The communication between the immobilizer 10 and the pickup blocker 11 and the encoder blocker 12 via the data bus 4 takes place cryptographically, for example by means of a challenge-response method and/or by means of an asymmetric signature method and/or by means of a method based on digital certificates and/or by means of a one-time password method.

The activation and deactivation of the immobilizer 10, i.e., the switching of the immobilizer 10 between the activated state and the deactivated state, takes place, in the exemplary embodiment shown, via a device 13 for access authorization to the vehicle 1, which is also referred to as access authorization device 13 below. The access authorization device 13 may comprise, for example, a vehicle key (not shown). In this case, the immobilizer 10 is in the activated state or is switched into the activated state in a rest state of the vehicle 1.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-10. (canceled)

11. A method for operating a vehicle having a steering axle and at least one wheel associated with the steering axle, a data bus, an immobilizer connected to the data bus, and a steer-by-wire steering device which comprises a steering encoder, a steering pickup component connected to and configured to sense a steering movement of the steering encoder, and a steering actuator configured to control the at least one wheel of the steering axle, the method comprising:
switching the immobilizer into a deactivated state in which
the steering pickup component senses the steering movement of the steering encoder and transmits steering information dependent on the steering movement to the data bus, and
the steering actuator receives the steering information via the data bus and controls the at least one wheel of the steering axle depending on the steering information; and
switching the immobilizer into a activated state in which
the transmission of the steering information to the data bus is blocked in the steering pickup component by software, or
the control of the at least one wheel of the steering axle is blocked in the steering actuator by software.

12. The method of claim 11, wherein a pickup blocker is integrated by software in the steering pickup component, and the immobilizer communicates with the pickup blocker via the data bus, wherein the immobilizer activates the pickup blocker in the activated state such that the pickup blocker blocks the transmission of the steering information to the data bus.

13. The method of claim 12, wherein the immobilizer communicates with the pickup blocker by cryptographic communication.

14. The method of claim 11, wherein an encoder blocker is integrated by software in the steering actuator, and the immobilizer communicates with the encoder blocker via the data bus, wherein the immobilizer activates the encoder blocker in its activated state such that the encoder blocker blocks the control of the at least one wheel of the steering axle.

15. The method of claim 14, wherein the immobilizer communicates with the encoder blocker by cryptographic communication.

16. The method of claim 11, wherein the immobilizer is switched between the deactivated state and the activated state by an access authorization device of the vehicle.

17. The method of claim 11, wherein the immobilizer is switched into the activated state in a rest state of the vehicle.

18. A vehicle comprising:
a steering axle;
at least one wheel associated with the steering axle;
a data bus;
a steer-by-wire steering device which comprises
a steering encoder,
a steering pickup component connected to the steering encoder and configured to sense a steering movement of the steering encoder, and
a steering actuator configured to control the at least one wheel of the steering axle; and
an immobilizer connected to the data bus,
wherein, when the immobilizer is switched into a deactivated state
the steering pickup component is configured to sense the steering movement of the steering encoder and configured to transmit steering information dependent on the steering movement to the data bus, and
the steering actuator is configured to receive the steering information via the data bus and configured to control the at least one wheel of the steering axle depending on the steering information, and
wherein, when the immobilizer is switched into a activated state
software in the steering pickup component is configured to block the transmission of the steering information to the data bus, or
software in the steering actuator blocks the control of the at least one wheel of the steering axle.

19. The vehicle of claim 18, wherein the steering encoder is free of mechanical locks and is foldable.

20. The vehicle of claim 18, wherein the steering device is free of mechanical locks between the steering encoder and the steering pickup component.

21. The vehicle of claim 18, wherein the steering device is free of mechanical locks between the steering actuator and the at least one wheel of the steering axle.
